(19) United States
(12) Patent Application Publication
(10) Pub. No.: US 2009/0101280 A1
(43) Pub. Date: Apr. 23, 2009

(54) METHOD OF PRODUCING FLEXIBLE SINGLE-SIDED POLYIMIDE COPPER-CLAD LAMINATE

(75) Inventors: Jun ASAZUMA, Kamisu-shi (JP); Masahiro USUKI, Kamisu-shi (JP); Tadashi AMANO, Kamisu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/253,629

(22) Filed: Oct. 17, 2008

(30) Foreign Application Priority Data
Oct. 18, 2007 (JP) 2007-271855

(51) Int. Cl. C09J 201/08

(52) U.S. Cl. 156/331.1

(57) ABSTRACT

A method of producing a flexible single-sided polyimide copper-clad laminate having excellent flex properties. The method comprises: (A) forming a polyamic acid coating by applying a polyamic acid to the surface of a copper foil starting material, (B) forming a laminate by bonding a polyimide film to the polyamic acid coating, and (C) heat treating the laminate, wherein the copper foil starting material is a material for which, if the copper foil starting material is subjected to a heat treatment for 30 minutes at 200° C. in a non-oxidizing atmosphere and the intensity of the (200) plane determined by X-ray diffraction following this heat treatment is termed I, and if the intensity of the (200) plane determined by X-ray diffraction of a copper powder that has not been subjected to heat treatment is termed I₀, I and I₀ satisfy a relationship represented by a formula (I) shown below:

I/I₀>20 (I).

### BACKGROUND OF THE INVENTION

1. Field of the Invention

The present invention relates to a method of producing a flexible single-sided polyimide copper-clad laminate in which a copper foil is laminated to the surface of a heat-resistant polyimide film with a heat-resistant polyimide layer disposed therebetween as an adhesive layer.

2. Description of the Prior Art

In recent years, as electronic devices such as portable telephones have become thinner and smaller, improved flex properties are being demanded of the flexible substrates used in such devices. Specifically, a high-level flex performance that results in no circuit breakage upon conducting an IPC flex test is required. Furthermore, in order to conform to real life environments, this high-level flex performance must be maintained over a broad temperature range from high temperatures to below freezing.

Conventionally, flexible substrates have been produced by coating a conductor directly with a polyimide precursor resin solution, and then drying and curing the solution (see Patent Reference 1, Patent Reference 2, Patent Reference 3 and Patent Reference 4). Furthermore, methods in which application of the polyimide precursor resin solution to the conductor is split into several coating repetitions are also known (see Patent Reference 5, Patent Reference 6, Patent Reference 7 and Patent Reference 8).

However, in methods where either a single application or several application repetitions are used to form a polyimide layer with a thickness of at least 20 μm on top of the conductor, the overall polyimide layer on the flexible substrate is prone to discontinuity in both the thickness direction and the in-plane direction, and therefore the flex performance at high temperatures tends to be unsatisfactory.

Furthermore, another known production method includes a heat treatment process of applying a polyimide precursor resin solution to the surface of a copper foil containing silver or the like that has been subjected to a preliminary surface roughening or plating treatment, and subsequently drying and curing the solution, wherein the copper foil is recrystallized during the heat treatment process (see Patent Reference 9). It is claimed that this method enables the production of a flexible copper-clad laminate with superior flex properties. However, the flex properties of a flexible copper-clad laminate obtained using this method tend to be unsatisfactory when subjected to more than one million flex repetitions.

[Patent Reference 1] JP59-232455A

[Patent Reference 2] JP61-275325A

[Patent Reference 3] JP62-212140A

[Patent Reference 4] JP7-57540A

[Patent Reference 5] JP2-180682A

[Patent Reference 6] JP2-180679A

[Patent Reference 7] U.S. Pat. No. 4,937,133

[Patent Reference 8] JP2-122697A

[Patent Reference 9] JP2006-237048A

### SUMMARY OF THE INVENTION

Accordingly, an object of the present invention is to provide a method of producing a flexible single-sided polyimide copper-clad laminate with excellent flex properties that favorably harnesses the properties of a heat-resistant polyimide resin film having excellent levels of heat resistance, chemical resistance, flame retardancy and flexibility.

In order to achieve the above object, the present invention provides a method of producing a flexible single-sided polyimide copper-clad laminate comprising a polyimide film, a polyimide adhesive layer provided on top of the polyimide film, and a copper foil provided on top of the polyimide adhesive layer, the method comprising:
(A) applying a polyamic acid to a surface of a copper foil starting material to form a polyamic acid coating thereon,
(B) bonding a polyimide film to the polyamic acid coating to form a laminate, and
(C) heat treating the laminate, wherein

the copper foil starting material is a material for which, if the copper foil is subjected to a heat treatment for 30 minutes at 200° C. in a non-oxidizing atmosphere and the intensity of the (200) plane determined by X-ray diffraction following this heat treatment is termed I, and if the intensity of the (200) plane determined by X-ray diffraction of a copper powder that has not been subjected to heat treatment is termed I₀, I and I₀ satisfy a relationship represented by a formula (I) shown below:

I/I₀>20 (I).

The method of the present invention enables the production of a flexible single-sided polyimide copper-clad laminate with superior flex properties, that exhibits excellent levels of heat resistance, chemical resistance, flame retardancy and flexibility, and suffers no circuit breakage even when subjected to more than one million flex repetitions in the IPC flex test.

### DETAILED DESCRIPTION OF THE PREFERRED EMBODIMENTS

The production method of the present invention is described below in more detail, in a sequential manner.

### —(A) Formation of Polyamic Acid Coating on Copper Foil—

The copper foil used as a starting material in the present invention is a material for which, if the copper foil is subjected to a heat treatment for 30 minutes at 200° C. in a non-oxidizing atmosphere and the intensity of the (200) plane determined by X-ray diffraction following this heat treatment is termed I, and if the intensity of the (200) plane determined by X-ray diffraction of a copper powder that has not been subjected to heat treatment is termed I₀, I and I₀ satisfy a relationship represented by a formula (I) shown below:

I/I₀>20 (I).

The copper foil used as the starting material may be a copper foil produced by a typical rolling process, although the copper foil must satisfy the relationship of the above formula (I), and preferably satisfies I/I₀>100. If the value of I/I₀ is 20 or less, then the growth of the copper crystal grains is unsatisfactory, cracking is more likely to occur at the crystal grain boundaries, and achieving satisfactory flex properties becomes difficult.

The heat treatment mentioned above must be conducted within a non-oxidizing atmosphere, and may be conducted, for example, in a reduced pressure atmosphere of 1,000 Pa or less, or in an atmosphere of an inert gas such as argon gas or nitrogen gas.

The copper powder used as a standard within the above formula (I) is a copper powder that has been subjected to absolutely no treatments following refining.

For reasons such as suppressing wrinkling during production, achieving superior strength in the lamination step, avoiding the need for a protective material, and ensuring satisfactory flexibility, the thickness of the copper foil starting material is typically within a range from 9 to 18 μm, and is preferably from 9 to 12 μm.

In this step, a polyamic acid coating is formed by applying a polyamic acid that functions as a polyimide resin precursor to the surface of the type of copper foil described above. The polyamic acid coating is typically formed by applying the polyamic acid in the form of an organic solvent solution (a varnish), and then drying the varnish. Examples of the organic solvent include polar solvents such as N-methyl-2-pyrrolidone (NMP) and N,N-dimethylacetamide (DMAc).

There are no particular restrictions on the apparatus and method used for applying the polyamic acid varnish to the treatment surface of the copper foil, and apparatus that may be used include a comma coater, die coater, roll coater, knife coater, reverse coater or lip coater.

The polyamic acid coating is typically semi-dried at a temperature at which imidization of the coating does not proceed (specifically, at a temperature for which imidization is suppressed to less than 5%), namely at a temperature of not more than 150° C., and preferably a temperature of 120° C. or lower. More specifically, in the subsequent step (B), when a polyimide film is positioned on top of the polyamic acid coating and subjected, for example, to thermocompression bonding, the polyamic acid coating has preferably been sufficiently dried to reduce the solvent content to a value within a range from approximately 3 to 50% by mass. If the solvent content of the polyamic acid coating is too high during step (B), then various problems may arise during the thermocompression bonding, including foaming or swelling of the polyamic acid coating (and therefore the polyimide adhesive layer), and flowing of the polyamic acid varnish that can cause a deterioration in the workability and contamination of the rollers. In contrast, if the solvent content is to low, then a high temperature and high pressure are required for the thermocompression bonding, which requires specialized equipment.

The thickness of the polyamic acid coating formed in this manner, following imidization in the subsequent step (C) and conversion to a polyimide adhesive layer, is typically not more than 5 μm, and is preferably from 1 to 4 μm.

The polyamic acid applied as an adhesive is known to be produced by a condensation reaction between a diamine component and a tetracarboxylic dianhydride component (also referred to as the acid anhydride component). The polyamic acid is a precursor to a polyimide resin, and in the production method of the present invention, the heat treatment performed in step (C) causes a ring-closing reaction that results in a polyimidization, thereby yielding the polyimide adhesive layer of the product flexible single-sided polyimide copper-clad laminate.

Examples of the acid anhydride component include tetracarboxylic anhydrides and derivatives thereof such as esterified derivatives and acid chloride derivatives.

Specific examples of the acid anhydride component include pyromellitic anhydride, 3,3′,4,4′-biphenyltetracarboxylic anhydride, 3,3′,4,4′-benzophenonetetracarboxylic anhydride, 3,3′,4,4′-diphenylsulfonetetracarboxylic anhydride, 3,3′,4,4′-diphenyl ether tetracarboxylic anhydride, 2,3,3′,4′-benzophenonetetracarboxylic anhydride, 2,3,6,7-naphthalenetetracarboxylic anhydride, 1,2,5,6-naphthalenetetracarboxylic anhydride, 3,3′,4,4′-diphenylmethanetetracarboxylic anhydride, 2,2-bis(3,4-dicarboxyphenyl)propane anhydride, 2,2-bis(3,4-dicarboxyphenyl)hexafluoropropane anhydride, 3,4,9,10-tetracarboxyperylene anhydride, 2,2-bis[4-(3,4-dicarboxyphenoxy)phenyl]propane anhydride, 2,2-bis[4-(3,4-dicarboxyphenoxy)phenyl]hexafluoropropane anhydride, butanetetracarboxylic anhydride, and cyclopentanetetracarboxylic anhydride.

Furthermore, examples of the diamine component include diamines such as p-phenylenediamine, m-phenylenediamine, 2′-methoxy-4,4′-diaminobenzanilide, 4,4′-diaminodiphenyl ether, diaminotoluene, 4,4′-diaminodiphenylmethane, 3,3′-dimethyl-4,4′-diaminodiphenylmethane, 2,2-bis[4-(4-aminophenoxy)phenyl]propane, 1,2-bis(anilino)ethane, diaminodiphenyl sulfone, diaminobenzanilide, diaminobenzoate, diaminodiphenyl sulfide, 2,2-bis(p-aminophenyl)propane, 2,2-bis(p-aminophenyl)hexafluoropropane, 1,5-diaminonaphthalene, diaminobenzotrifluoride, 1,4-bis(p-aminophenoxy)benzene, 4,4′-(p-aminophenoxy)biphenyl, diaminoanthraquinone, 4,4′-bis(3-aminophenoxyphenyl)diphenyl sulfone, 1,3-bis(anilino)hexafluoropropane, 1,4-bis(anilino)octafluoropropane, 1,5-bis(anilino)decafluoropropane, 1,7-bis(anilino)tetradecafluoropropane, 2,2-bis[4-(p-aminophenoxy)phenyl]hexafluoropropane, 2,2-bis[4-(3-aminophenoxy)phenyl]hexafluoropropane, 2,2-bis[4-(2-aminophenoxy)phenyl]hexafluoropropane, 2,2-bis[4-(4-aminophenoxy)-3,5-dimethylphenyl]hexafluoropropane, 2,2-bis[4-(4-aminophenoxy)-3,5-ditrifluoromethylphenyl]hexafluoropropane, p-bis(4-amino-2-trifluoromethylphenoxy)benzene, 4,4′-bis(4-amino-2-trifluoromethylphenoxy)biphenyl, 4,4′-bis(4-amino-3-trifluoromethylphenoxy)biphenyl, 4,4′-bis(4-amino-2-trifluoromethylphenoxy)diphenyl sulfone, 4,4′-bis(4-amino-5-trifluoromethylphenoxy)diphenyl sulfone, 2,2-bis[4-(4-amino-3-trifluoromethylphenoxy)phenyl]hexafluoropropane, benzidine, 3,3′,5,5′-tetramethylbenzidine, octafluorobenzidine, 3,3′-methoxybenzidine, o-tolidine, m-tolidine, 2,2′,5,5′,6,6′-hexafluorotolidine, 4,4″-diaminoterphenyl, and 4,4′″-diaminoquarterphenyl, as well as diisocyanates obtained through reaction of the above diamines with phosgene or the like, and diaminosiloxanes.

The acid anhydride component and diamine component described above may each use either a single compound, or a combination of two or more different compounds.

Of the polyamic acid components listed above, a polyamic acid obtained by reacting 4,4′-diaminodiphenyl ether and pyromellitic anhydride, and a polyamic acid obtained by reacting p-phenylenediamine is preferred. A polyamic acid obtained by reacting 4,4′-diaminodiphenyl ether and pyromellitic anhydride is particularly desirable. In the polyamic acid used, the quantity of these preferred polyamic acids preferably represents at least 50% by mass, even more preferably 75% by mass or greater, and is most preferably 100% by mass.

The condensation reaction used to prepare the polyamic acid is typically conducted within a single solvent such as N-methylpyrrolidone (NMP) or N,N-dimethylacetamide (DMAc), or within a mixed solvent of DMAc and NMP. The reaction is preferably conducted under conditions including a reaction temperature of 10 to 40° C., a concentration of the reaction components within the reaction solution of not more than 30% by mass, a molar ratio between the acid anhydride component and the diamine component within a range from 0.95:1.00 to 1.05:1.00, and under an atmosphere of nitrogen.

The polyamic acid stated above can be used singly or in combination of two or more kinds.

The polyamic acid that acts as an adhesive may also include inorganic, organic or metallic substances, in either powdered or fibrous form, such as silicon dioxide or silane coupling agents or the like, which are added for the purpose of improving various properties of the polyimide adhesive layer generated from the polyamic acid. Furthermore, other additives that may also be added include antioxidants for preventing oxidation of the copper foil conductor, silane coupling agents for improving the adhesion, and leveling agents for improving the coating properties.

### —(B) Bonding Polyimide Film and Forming Laminate—

In this step, a polyimide film is bonded to the polyamic acid coating formed on top of the copper foil starting material in step (A), thereby forming a laminate composed of the copper foil, the polyamic acid coating, and the polyimide film.

Specifically, as described above, the polyamic acid coating obtained in step (A) is typically in a semi-dried state, and the polyimide film that acts as a substrate is placed on top of this polyamic acid coating, and the resulting structure is then pressure bonded using a hot roller press or the like to complete preparation of the laminate.

The polyimide film used has a high level of heat resistance, and functions as a substrate film. Any polyimide film obtained by imidization of a polyamic acid coating containing a polyamic acid synthesized from any of the various acid anhydride components and diamine components described above may be used, but of the various possibilities, a film obtained by heat curing a polyamic acid obtained by reacting 4,4′-diaminodiphenyl ether and pyromellitic anhydride is preferred.

The polyimide film can be obtained by casting the polyamic acid on top of a substrate such as a metal sheet, a glass sheet or a rotating drum or the like, heating the polyamic acid to dry the solvent and effect the imidization, and then peeling the film away from the substrate.

The polyimide film used in this step has a thickness that is typically not more than 25 μm, and is preferably within a range from 6 to 22 μm, and even more preferably from 8 to 20 μm.

Furthermore, the polyimide film may also be subjected to a plasma treatment or etching treatment on the surface of the film that is to be bonded.

In those cases where the polyimide film undergoes thermocompression bonding to the polyamic acid coating using a roller press, examples of the method used for heating the roller press include methods in which the rollers are heated directly using oil or steam or the like. As a minimum requirement, the roller that contacts the copper foil must be heated. The rollers may be metal rollers formed from carbon steel or the like, or rubber rollers formed from a heat-resistant NBR rubber, fluororubber or silicone rubber or the like. Although there are no particular restrictions on the roller press conditions, the roller temperature is preferably within a range from 100 to 150° C., which represents a temperature that is at least as high as the softening point of the semi-dried polyamic acid but is not higher than the boiling point of the solvent, and the linear pressure is preferably within a range from 5 to 100 kg/cm.

Drying of the solvent following formation of the laminate is preferably conducted at a temperature that is not higher than the boiling point of the solvent used in the polyamic acid varnish. Because the solvent drying occurs by removal of the solvent through the bonded polyimide film, sufficient time should be provided for the solvent removal, and the drying is typically conducted over a period of 3 to 30 hours.

### —(C) Heat Treatment of Laminate—

The laminate obtained in step (B) is subjected to a heat treatment, thereby imidizing the polyamic acid coating and forming a polyimide adhesive layer.

This heat treatment is typically conducted under a non-oxidizing atmosphere, and more specifically within an atmosphere having an oxygen concentration that is sufficiently low (not more than 2%) to preclude oxidation of the copper foil. For example, the heat treatment may be conducted under reduced pressure or within an inert gas atmosphere of nitrogen or the like, at a temperature of 250 to 350° C. The treatment time varies depending on the treatment temperature, but is typically within a range from 3 to 20 hours. The temperature and treatment time are preferably selected so that the imidization proceeds in a manner that yields a uniform film thickness for the resulting polyimide adhesive layer.

There are no restrictions on the configuration of the laminate during the aforementioned solvent removal and the heat treatment (imidization) of this step. For example, the laminate may be in either a sheet form or a rolled form. In the case of a rolled form, there are no particular restrictions on the method used for winding the roll, and the laminate may be rolled with the copper foil facing either inward or outward, or may be rolled with a spacer sandwiched between individual winds of the laminate. In order to accelerate the evaporation of residual solvent within the laminate during the solvent removal and heat treatment, and accelerate the evaporation of the water generated by the condensation that occurs during imidization, the roll is preferably either wound loosely, or wound with a spacer of a different material sandwiched between the winds of the roll.

### —Flexible Single-sided Copper-clad Laminate—

In a flexible single-sided polyimide copper-clad laminate of the present invention obtained in the manner described above, the total thickness of the polyimide resin layer, namely the combined thickness of the polyimide film substrate and the polyimide adhesive layer, is preferably within a range from 7 to 26 μm, and is even more preferably from 9 to 24 μm. If this total thickness is too thin, then the flexible single-sided polyimide copper-clad laminate may be prone to wrinkling when wound in roll form for transport, whereas if the thickness is too great, then the flex properties of the laminate deteriorate.

### EXAMPLES

A more detailed description of the present invention is presented below based on a series of examples.

### Synthesis Example 1

[Polyamic Acid A]

202.5 g of 4,4′-diaminodiphenyl ether was dissolved in 1.5 kg of N,N-dimethylacetamide, and the resulting solution was held at 10° C. under a nitrogen atmosphere and under constant stirring. Subsequently, 218.5 g of pyromellitic anhydride was added gradually to this solution held at 10° C. so that the internal temperature did not exceed 15° C. The reaction was then permitted to proceed at 10 to 15° C. for two hours, and then for a further 6 hours at room temperature (20° C.).

### Synthesis Example 2

[Polyamic Acid B]

108.5 g of p-phenylenediamine was dissolved in 2 kg of N,N-dimethylacetamide, and the resulting solution was held at 10° C. under a nitrogen atmosphere and under constant stirring. Subsequently, 295.7 g of 3,3′,4,4′-biphenyltetracarboxylic anhydride was added gradually to this solution held at 10° C. so that the internal temperature did not exceed I 5° C. The reaction was then permitted to proceed at 10 to 15° C. for two hours, and then for a further 6 hours at room temperature (20° C.).

### Examples 1 to 5

Preparation of Laminates

The values of I₀ for a copper powder that had undergone no heat treatment and I for the rolled copper foils used in the examples were determined in advance using X-ray diffraction.

Rolled copper foils having the thickness and I/I₀ values shown in Table I were cut to dimensions of 30 cm×25 cm. The I and I₀ values are as described above. A mixture obtained by mixing the polyamic acids A and B in a ratio of 4:1 (mass ratio) was applied to each of the copper foil samples using an applicator. In each case, the copper foil that had been coated with the polyamic acid mixture in this manner was then dried for 2 minutes at 120° C. in an oven. Subsequently, a polyimide film (hereafter also abbreviated as PI film) having the product name and thickness shown in Table 1 and cut to dimensions of 30 cm×25 cm was overlaid on the polyamic acid-coated surface of the copper foil bearing the polyamic acid coating, and a test roll laminator apparatus manufactured by Nishimura Machinery Co., Ltd. was used to laminate the structure under conditions including a temperature of 120° C., a pressure of 15 kg/cm, and a speed of 4 m/min. The resulting laminate was subjected to a continuous heat treatment under a reduced pressure of 100 Pa or lower using a vacuum drying apparatus, by heating for 4 hours at 160° C., a further one hour at 250° C., and yet a further one hour at 350° C., thus forming a polyimide adhesive layer with the thickness shown in Table 1. In this manner, a flexible single-sided polyimide copper-clad laminate was obtained.

### Comparative Examples 1 to 3

With the exception of using copper foils having the thickness and I/I₀ values shown in Table 2, flexible single-sided polyimide copper-clad laminates were prepared in the same manner as Examples 1 to 5.

[Measurement of Flex Properties]

Measurement of IPC Flex Property

A circuit pattern having a circuit width of 150 μm and an insulating layer width of 150 μm was formed in the copper foil layer of each of the flexible single-sided polyimide copper-clad laminates produced in the above examples and comparative examples. A coverlay film (product name: CN211) manufactured by Shin-Etsu Chemical Co., Ltd. was thermocompression bonded to each of the formed circuit patterns under conditions including a pressure of 50 kgf/cm², a temperature of 160° C. and a bonding time of 40 minutes. Using this flexible single-sided polyimide copper-clad laminate with a coverlay film thermocompression bonded thereto as a test piece, a high-speed flexural endurance tester manufactured by Shin-Etsu Engineering Co., Ltd. was used to subject the test piece to repeated flexion, with the coverlay film positioned on the inside of each flexion and with the flexion performed under conditions including a flex radius of 1.5 mm, a flex speed of 600 repetitions/minute and a stroke of 20 mm. The electrical resistance was measured following 5 million flex repetitions, and the rate of increase in the electrical resistance value was calculated relative to the initial electrical resistance.

TABLE 1

| | Example 1 | Example 2 | Example 3 | Example 4 | Example 5 |
|---|---|---|---|---|---|
| Copper thickness (μm) | 12 | 18 | 18 | 12 | 18 |
| Copper layer I/I₀ | 107 | 107 | 107 | 107 | 107 |
| PI film (product name) | Apical NPI | Apical NPI | Apical NPI | Apical NPI | Apical NPI |
| PI film thickness (μm) | 10 | 10 | 10 | 18 | 18 |
| Polyimide adhesive | 1.7 | 1.7 | 2.4 | 1.8 | 1.8 |
| layer thickness (μm) | | | | | |
| Test temperature (° C.) | −10 | 60 | −10 | 60 | −10 |
| Rate of increase in | 2.3 | 4.0 | 2.9 | 8.5 | 6.5 |
| electrical resistance (%) | | | | | |

TABLE 2

| | Comparative | Comparative | Comparative |
|---|---|---|---|
| | Example 1 | Example 2 | Example 3 |
| Copper thickness (μm) | 12 | 12 | 18 |
| Copper layer I/I₀ | 6 | 6 | 6 |
| PI film (product name) | Apical NPI | Apical NPI | Apical NPI |
| PI film thickness (μm) | 18 | 18 | 10 |
| Polyimide adhesive | 1.8 | 1.8 | 1.7 |
| layer thickness (μm) | | | |
| Test temperature (° C.) | −10 | 60 | −10 |
| Rate of increase in | 13.3 | 18.0 | 12.0 |
| electrical resistance (%) | | | |

Evaluations:

In Examples 1 to 5, the rate of increase in the electrical resistance was within a range from 2.3 to 8.5%, whereas in Comparative Examples 1 to 3, the rate of increase was from 12.0 to 18.0%. It is clear that the laminates of the examples exhibited flex properties that were markedly superior to those of the laminates of the comparative examples.

What is claimed is:

1. A method of producing a flexible single-sided polyimide copper-clad laminate comprising a polyimide film, a polyimide adhesive layer provided on top of the polyimide film, and a copper foil provided on top of the polyimide adhesive layer, the method comprising:
(A) applying a polyamic acid to a surface of a copper foil starting material to form a polyamic acid coating thereon,
(B) bonding a polyimide film to the polyamic acid coating to form a laminate, and
(C) heat treating the laminate, wherein
the copper foil starting material is a material for which, if the copper foil starting material is subjected to a heat treatment for 30 minutes at 200° C. in a non-oxidizing atmosphere and an intensity of a (200) plane determined by X-ray diffraction following this heat treatment is termed I, and if an intensity of a (200) plane determined by X-ray diffraction of a copper powder that has not been subjected to heat treatment is termed I₀, I and I₀ satisfy a relationship represented by a formula (I) shown below:
I/I₀>20 (I).

2. The method according to claim 1, wherein a thickness of the polyimide film is not more than 25 μm, and a thickness of the polyimide adhesive layer is not more than 10 μm.

3. The method according to claim 1, wherein I and I₀ satisfy I/I₀>100.

4. The method according to claim 1, wherein a thickness of the copper foil starting material used in step (A) is within a range from 9 to 18 μm.

5. The method according to claim 1, wherein the polyamic acid used in step (A) is a polyamic acid obtained by reacting 4,4′-diaminodiphenyl ether and pyromellitic anhydride, or a mixture containing at least 50% by weight of a polyamic acid obtained by reacting p-phenylenediamine and pyromellitic anhydride, and less than 50% by weight of another polyamic acid.

6. The method according to claim 1, wherein the polyamic acid used in step (A) is a mixture containing at least 50% by weight of a polyamic acid obtained by reacting 4,4′-diaminodiphenyl ether and pyromellitic anhydride, and less than 50% by weight of another polyamic acid.

7. The method according to claim 1, wherein the polyimide film used in step (B) has been subjected to a plasma treatment or an etching treatment.
